(19) United States
(12) Patent Application Publication
(10) Pub. No.: US 2015/0331909 A1
(43) Pub. Date: Nov. 19, 2015

(54) APPLICATION PROGRAMMING INTERFACE FOR TABULAR GENOMIC DATASETS

(71) Applicant: DNANEXUS INC, Mountain View, CA (US)

(72) Inventors: Andreas SUNDQUIST, Mountain View, CA (US); George ASIMENOS, Mountain View, CA (US); Evan M. WORLEY, Mountain View, CA (US); Philip SUNG, Mountain View, CA (US); Katherine LAI, Mountain View, CA (US)

(21) Appl. No.: 14/652,421

(22) PCT Filed: Dec. 19, 2013
(86) PCT No.: PCT/US2013/076745

§ 371 Date: Jun. 15, 2015

Related U.S. Application Data
(60) Provisional application No. 61/740,215, filed on Dec. 20, 2012.

(51) Int. Cl. G06F 17/30; G06F 19/28

(52) U.S. Cl. CPC G06F 17/30477; G06F 17/30554; G06F 17/30864; G06F 19/28

(57) ABSTRACT

A computer application programming interface (API) for interacting with genomic data. Genomic data is stored by a genomic information provider using cloud-optimized, tabular structures in the form of genomic tables. A client computer may instruct, via API method calls, the genomic information provider to create a genomic table. Client computers may add genomic data to the genomic table via additional API method calls. A client computer may close the genomic table via an API method call. Once closed, client computers may retrieve genomic data based on genomic coordinates from the genomic table via API method calls. In this way, the transmission of genomic data via flat files can be avoided.

### CROSS-REFERENCE TO RELATED APPLICATION

This application claims the benefit of U.S. Provisional Application 61/740,215 filed on Dec. 20, 2012, the entire contents of which are incorporated herein by reference for all purposes.

### BACKGROUND

1. Field

The present disclosure relates generally to management of bioinformatics information, and more specifically to the managing of bioinformatics information using application programming interfaces.

2. Description of Related Art

Genomics researchers use, among other instruments, next-generation DNA sequencers that produce large datasets of bioinformatics information to facilitate research. The large datasets of bioinformatics information are typically transferred to and stored on computers for later retrieval and manipulation. Today, more than 500 terabytes of bioinformatics information (e.g., genomic information such as DNA sequence data) are known to exist and are managed by various computer systems. The amount of bioinformatics information that will need to be managed will likely rise as genomics research further progresses.

Despite advances in computing and networking technologies, the meaningful storage and transmission of even a fraction of the available bioinformatics information cause technical challenges that have not been meaningfully overcome. For example, the file sizes necessary for storing genomic data can easily exceed the limits of popular computing system architectures. The transmission of chunks of genomic data can also easily overburden existing network infrastructures.

Some laboratories transmit bioinformatics information by sending computer disks via express mail, because existing solutions for transmitting and storing the bioinformatics information would be even more cumbersome. In short, a unified technology platform for meaningfully storing and/or managing bioinformatics information does not exist.

### BRIEF SUMMARY

In some embodiments, a genomic information provider receives one or more Application Programming Interface (API) method calls from a computing device, and transmits genomic information to the calling computing device. The genomic information is stored by the genomic information provider as tabular data in a genomic table. The API method call can identify the genomic table. The API method can identify a chromosome stored on the genomic table. The API method call can use a genomic range index to identify genomic data within the genomic table. Based on the identified information, the genomic information provider returns to the computing device, output comprising: a plurality of table rows corresponding to the subset of the genomic information dataset, and a length indicator indicating the number of table rows in the plurality of table rows. The genomic range index identifies genomic coordinates associated with the subset of the genomic information datasets.

In some embodiments, the genomic information is stored in a cloud-based storage device and/or service that may be provided by a third-party service provider. The genomic information provider may manage the transmission and/or storage of genomic information at the cloud-based storage device and/or service. In some embodiments, the genomic range index identifies a genomic interval on a chromosome, and the genomic range index may comprise a composite index having three portions comprising: a first portion identifying the chromosome, a second portion identifying a low boundary of the genomic interval on the chromosome, and a third portion representing a high boundary of the genomic interval on the chromosome.

### DESCRIPTION OF THE FIGURES

FIG. 1 depicts an exemplary system for storing and/or transmitting bioinformatics information.

FIG. 2 depicts exemplary states in the lifecycle of a genomic table.

FIG. 3 depicts an exemplary process for storing and/or transmitting bioinformatics information using a genomic table.

FIG. 4 depicts communication between exemplary computing devices to perform the storing and/or transmitting of bioinformatics information.

FIG. 5 depicts an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The embodiments described herein include a genomic information provider that provides computing technologies for storing and transmitting genomic information datasets to a requesting computing device. As used herein, the term “genomic information datasets” is also referred to as “genomic data.” Examples of genomic data include DNA sequencing data, such as DNA reads, DNA mappings, and DNA variants.

In some embodiments, the genomic information provider provides application programming interfaces (APIs) for storing and/or transmitting genomic data. APIs that are made accessible by the genomic information provider can be called by client computing devices over a network. In some embodiments, the genomic information provider provides computer instructions in the form of a software development toolkit (SDK). Software components of the SDK can be included in computer-executable instructions that run on client computing devices. Using the SDK components, client computing devices can request genomic data from the genomic information provider. In some embodiments, the genomic information provider provides a command line interface for manipulating genomic data. A client computing device may access the command line interface through a suitable shell environment, such as a LINUX shell environment, by connecting to the genomic information provider over a network.

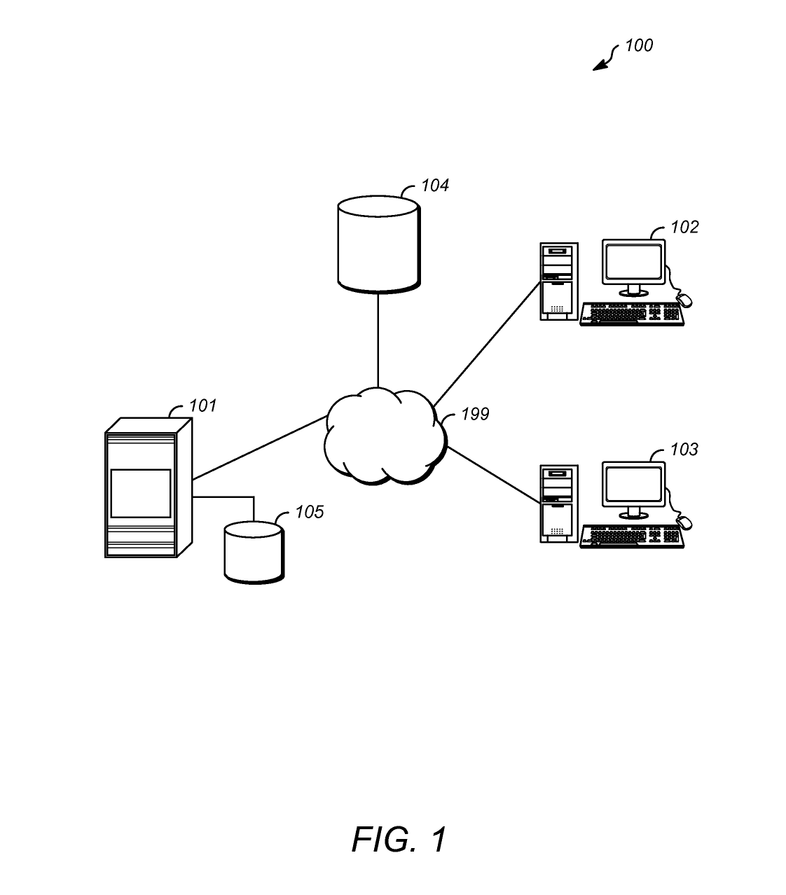

FIG. 1 illustrates an exemplary system for transmitting genomic data between a genomic information provider 101 and client computing devices. Genomic information provider 101 listens to and responds to API method calls for genomic data that are made by client computing devices 102 and/or 103. Genomic information provider 101 stores genomic data at cloud storage 104. Cloud storage 104 may be maintained by a third-party service provider such as AMAZON S3, MICROSOFT WINDOWS AZURE, or the like. In addition, genomic information provider 101 may, in the alternative to or in combination with cloud storage 104, store genomic data at “local” storage 105, which may be a direct-attach storage, a Storage Area Network (SAN), a Network Area Storage (NAS), or the like. Cloud storage 104 and “local” storage 105 both provide non-volatile data storage. Various computing components shown in FIG. 1 communicate over network 199, which may be the internet, a private network, a public network, or any other suitable network.

### 1. Genomic Tables

When genomic information provider 101 stores genomic data using cloud storage 104, the genomic data are stored as tabular data in a specific type of tables called genomic tables. Genomic tables are a cloud-optimized data structure for storing large amounts of tabular, genomic data. Genomic tables are different from flat file formats that are used to store genomic data, such as the FASTQ, SAM/BAM, and VCF formats, in that genomic tables structure genomic data in tabular format. Also, genomic tables can be queried using a genomic coordinate system and/or other indices.

The use of genomic tables is beneficial for several reasons. First, for example, APIs may be used to stream genomic data to and from genomic tables without using flat files as a medium for data transmission, and thereby avoid the need to compress and transfer massive flat files. Second, for example, multiple computing devices can read or write genomic data to a genomic table concurrently. Third, for example, genomic data stored within genomic tables are optimized through ordering and indexing processes that expedite the retrieval of stored genomic data.

Consistent with the understanding of “table” objects in the art of computer science, genomic tables consist of rows and columns of data, specifically, genomic data. Genomic data that is structured in this tabular format are also referred to as tabular (genomic) data. Each column of a genomic table contains data of a particular data type. Valid data types are listed in Table 1:

TABLE 1

| Type | Description | Size (bytes) |
|---|---|---|
| boolean | true or false | 1 |
| uint8 | representing integers in the range 0 to 255 | 1 |
| int16 | representing integers in the range −32,768 to | 2 |
| | 32,767 | |
| uint16 | representing integers in the range 0 to 65,636 | 2 |
| int32 | representing integers in the range −2,147,483,648 | 4 |
| | to 2,147,483,647 | |
| uint32 | representing integers in the range 0 to | 4 |
| | 4,294,967,295 | |
| Int -or- | representing integers between −2⁶³ and 2⁶³ − 1 | 8 |
| int64 | that can be represented by an IEEE 754 | |
| | double-precision number. This includes all | |
| | integers between −9,007,199,254,740,992 and | |
| | 9,007,199,254,740,992. Note, this type has a | |
| | range that is different from the full range of a | |
| | 64-bit integer. | |
| Float | representing single-precision floating point | 4 |
| | numbers as defined in IEEE 754 | |
| double | representing double-precision floating point | 4 |
| | numbers as defined in IEEE 754 | |
| String | representing Unicode strings of variable length | (Length of |
| | | UTF-8 |
| | | encoding of |
| | | string) + 4 |

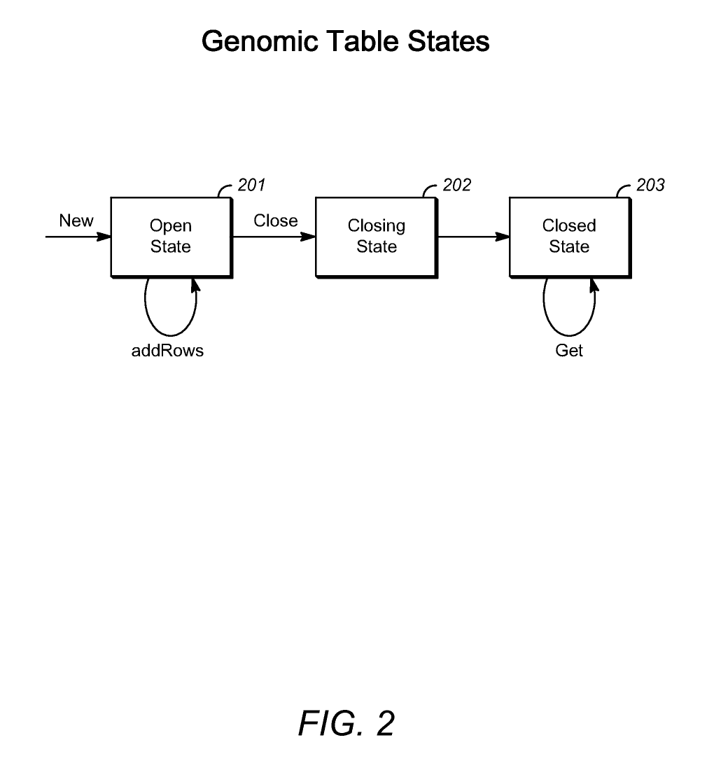

Genomic tables are stateful. FIG. 2 illustrates the possible states that may be assigned, by the genomic information provider, to a genomic table. The possible actions that may be taken, by a client computing device against a genomic table, vary depending on the state of the genomic table.

When a client computing device requests the genomic information provider to create a genomic table, a genomic table is created and is assigned “open” state 201. While a genomic table is in “open” state 201, a client computing device may add rows to the genomic table by calling the appropriate API method that is provided by the genomic information provider. A client computing device cannot, however, retrieve data from a genomic table that is in “open” state 201 until the genomic table advances from “open” state 201 to “closed” state 203.

When the genomic information provider receives, from a client computing device, a request to “close” the genomic table, the genomic information provider first places the genomic table into “closing” state 202. During “closing” state 202, genomic data that have been added to the genomic table (from one or more client computing devices over one or more API method calls) are aggregated, indexed, and ordered. The genomic table may not be read from or be written to during “closing” state 202. When the aggregation, indexing, and ordering of genomic data are complete, the genomic information provider places the genomic table in “closed” state 203. When a genomic table is placed into “closed” state 203, client computing devices may retrieve genomic data from the genomic table rows through appropriate API method calls to the genomic information provider.

### 2. Indexing and Ordering of Data in Genomic Tables

Genomic data are read from a genomic table using a query (e.g., a request). The types of queries that may be used to read genomic data from a genomic table depend on the indices that are created for the genomic table. During the creation of a genomic table, one or more indices may be defined for the genomic table. Each index allows the genomic table to be queried using a corresponding query. Exemplary indices that may be created for a genomic table include a genomic range index and a lexicographic index.

A genomic range index may be created for a genomic table. When a genomic range index is created for a genomic table, genomic data can be read from the genomic table using a query that uses a genomic coordinate system. The genomic range index is a composite index that is based on three genomic table columns: (i) a column of type string, representing the name of a chromosome, referred to as the “chr” column; and (ii) two columns, each of an integer type, representing the low and high boundaries of a genomic interval on the chromosome, which are referred to as the “lo” and “hi” columns, respectively. The “lo” and “hi” columns may be of, for example, uint8, int16, uint16, int32, uint32, int64 type. The “lo” and “hi” columns may be of the same integer type. The beginning of a chromosome may be marked as any integer (that is supported by the integer type of the “lo” column,” preferably 0.

A genomic range index may be defined using JavaScript Object Notation (JSON) as follows:

{“name”: “NAME_OF_INDEX”, “type”: “genomic”, “chr”: C, “lo”: L, “hi”: H},
where C, L, and H are strings giving the column names associated with (i) the “chr” column and (ii) the “lo” and “hi” columns as discussed above, respectively.

A genomic range index may allow rows from a genomic table that are enclosed by a particular genomic interval to be queried using a genomic coordinate system that defines the particular genomic interval. That is, a genomic range index allows for fetching all the rows whose value of the (i) chromosome column matches a particular string that is specified in the query, and whose (ii) lo and hi columns are enclosed by a particular interval that is specified in the query. When a query with query values “CHR, LO, HI” is performed against a genomic table, the rows (chr, lo, hi) that match the following criteria are retrieved from the genomic table: CHR==chr and LO<=lo and HI>=hi.

A genomic range index may also allow rows from a genomic table that overlap a particular genomic interval to be queried using a genomic coordinate system that defines the particular genomic interval. That is, a genomic range index allows for fetching all the rows whose value of the (i) chromosome column matches a particular string that is specified in the query, and whose (ii) lo and hi columns cover an interval that overlaps a particular interval that is specified in the query. When a query with query values “CHR, LO, HI” is performed against a genomic table, the rows (chr, lo, hi) that match the following criteria are retrieved from the genomic table: CHR==chr and LO<hi and HI>lo.

A lexicographic index may be created for a genomic table. When a lexicographic index is created for a genomic table, genomic data within the genomic table are arranged according to the definition of the lexicographic index.

A lexicographic index may be defined using the following JSON notation:

{ “name”: “NAME_OF_INDEX”, “type”: “lexicographic”, “columns”:
[[COL_1, ORDER_1], [COL_2, ORDER_2] . . . ] },

where each COL_i is a string giving the name of a column of the genomic table and each ORDER_i specifies whether the column is to be indexed in ascending or descending order.

The lexicographic index supports the following kinds of queries on any prefix of the columns:

COL_{—}1==val_{—}1 and COL_{—}2==val_{—}2 and . . . and COL_(k−1)==val_(k−1) and COL_k OP val_k,
where OP is one of >, >=, or ==(or one of <, <=, or ==if ORDER_k is DESC).

As discussed above, genomic data within a genomic table are ordered during the closing of the genomic table according to the indices that are defined for the genomic table. If multiple indices are specified for a genomic table, then when the genomic table is closed, the rows of the genomic table are ordered by the first index given, and in addition, the ordering of rows is computed for each additional index. If no index is defined for a genomic table, then the rows of the genomic table retain the order in which they were added.

As discussed above, the ordering of rows in a genomic table varies according to the index for which the ordering is performed. The algorithms that are used to order rows in a genomic table thus also vary between index types.

When the rows of a genomic table are ordered for a genomic range index of the genomic table, the rows of the genomic table are ordered according to the following strategy: First, rows are ordered according to the UTF-8 contents of the “chr” column, based on a Unicode Code Point comparison. Ties are resolved by comparing the contents of the “lo” column, and further ties are resolved by comparing the contents of the “hi” column. Further ties are broken arbitrarily.

When the rows of a genomic table are ordered for a lexicographic index of the genomic table, the rows of the genomic table are ordered by a tuple containing the genomic table columns that are indexed (by the lexicographic index) while respecting the ascending or descending ordering for each column (as defined by the lexicographic index). The sequence of elements within the tuple follows the ordering of the genomic table columns given in the definition of the lexicographic index.

3. APIs for Interacting with Genomic Tables

A genomic information provider may be responsive to various API methods for interacting with genomic tables that are stored by the genomic information provider. Exemplary API methods for interacting with genomic tables are discussed in turn, below. For sake of clarity, the following terminologies are used describe the relationship between API method calls, the genomic information provider, and client computing devices: the genomic information provider provides API methods; a client computing device calls, or invokes, an API method that is provided by the genomic information provider; in response, the genomic information provider may perform certain actions and may return certain values to the calling (client) computing device.

### Exemplary API: New

The “new” API method creates new genomic table. In some embodiments, the “new” API method is called via the string “/gtable/new”. One of ordinary skill in the art would appreciate that the use of slashes (i.e., “/”) in computer science depends on a number of factors; for example, leading slashes are not always necessary in the syntax of a particular computer instruction. Thus, the “new” API method (as well as the API methods described below) may also be called by, for example, the string “gtable/new” and/or the string “//gtable/new”.

The “new” API method may support the following input parameters:

(i) an optional “name” string representing the name of the new genomic table. If a “name” is not provided, an internal identifier that is generated for the new genomic table will also be used as the name of the genomic table;
(ii) an array of column descriptors for the genomic table. Each column descriptor is a hash with the following key/values: a “name” key mapped to a string that represents column name and a “type” key mapped to a string that represents column type. Column names should conform to the regular expression [-./A-Za-z0-9_]+ and should not match representing the reserved pattern “______*______”. Column types should be one of the allowed types listed in Table 1. The ordering of columns in the new genomic table follows the ordering of elements in the array of column descriptors;
(iii) an array of index descriptors. This array may take on the form of the above-described JSON notations for defining genomic range indices or lexicographic indices. The term “array” is used here to refer to a computer data structure for storing information in sequence, consistent with its ordinary meaning in the art.

The “new” API method may return to the calling computing device an object identifier corresponding to the newly created genomic table. As one of ordinary skill in the art would appreciate, the new genomic table is an “object” as the term “object” is understood in the art of computer science, and the object identifier may be a pointer to the genomic table object.

A genomic table object identifier may be an alphanumeric string in the form of “gtable-xxxx”, for example, “gtable-B2qqq0XZJYBfZqZ2GZPQ005Y”. Note, the “xxxx” portion of “gtable-xxxx” is not limited to a string length to four. Rather, as shown in the foregoing example, the string “B2qqq0XZJYBfZqZ2GZPQ005Y”, which represents an exemplary “xxxx” portion of the form “gtable-xxxx,” is 24 characters and numbers in length. Different embodiments of the “new” API method may return object identifiers of different lengths. The object identifier may include non-numeric characters (including extended characters) only, numbers only, or a combination of both.

Exemplary API: addRows

The “addRows” API method adds rows to a target genomic table. In some embodiments, the “addRows” API is called via the string “/gtable-xxxx/addRows” to add rows to the genomic table that is identified by “gtable-xxxx”. The “addRows” method may be called one or more times, sequentially or concurrently, by one or more computing devices, for a target genomic table that is in the “open” state. When the “addRows” method is called multiple times, each call may specify a “part” identifier that identifies the corresponding additions to the genomic table.

The “addRows” API method may support the following input parameters:

(i) a “part” identifier, which is a number, representing a portion of genomic data that is being uploaded;
(ii) an array of rows to be added to the genomic table. Each row is an array of values that correspond to the columns of the target genomic table. When given in JSON, values for columns of type “string” should be strings, values for columns of type “Boolean” should be Boolean, and values for columns of other types should be numbers.

Unlike the uploading of a flat file, which requires the genomic information provider to provide the caller (i.e., the uploader) with a separate Uniform Resource Locator (URL) for the transmission, the uploading of genomic data through the “addRows” API method allows genomic data to be included with the API method call (as part of the “data” input field). That is, a separate URL need not be sent to the calling computing device for adding rows to a genomic table using the “addRows” API method.

If a session (e.g., a HTTP session) between the genomic information provider and a calling computing device is terminated before the completion of an “addRows” API method call, any data that is partially received by the genomic information provider is discarded. If an “addRows” API method call completes successfully, the rows are added to the genomic table, unless another request has been already completed for the same part identifier. In other words, if the “addRows” method is called multiple times specifying the same part identifier, only the first successful request is added to the target genomic table.

### Exemplary API: Close

The “close” API method initiates the closing of a target genomic table. In some embodiments, the “close” API is called via the string “/gtable-xxxx/close” to close the genomic table that is identified by “gtable-xxxx”.

During the closing process, the parts of genomic data that have been uploaded via one or more “addRows” API calls are aggregated in order according to the part identifier of each part, in the order of increasing part identifier. Part identifiers, which are specified as part of “addRows” API calls, need not be consecutive.

Because the closing process may be time consuming, the “close” API method may return to the calling computing device an acknowledgement that the closing process has been initiated, but need not return to the calling computing device an indication that the closing is complete.

### Exemplary API: Get

The “get” API method retrieves rows from a genomic table that is in the “closed” state. In some embodiments, the “get” API method is called via the string “/gtable-xxxx/get” to retrieve genomic data from the genomic table that is identified by “gtable-xxxx”.

The “get” API method may support the following input parameters:

(i) a “query” suitable for an index that has been created for the genomic table;
(ii) an array of column names identifying the columns that should be returned in the response;
(iii) a “limit” value, which is an integer, specifying the maximum number of rows of genomic data to be returned;
(iii) optionally, a “starting” value, which is an integer, specifying an offset into the results that match the query. When a “starting” value is given, rows of genomic data that match the query, but are located within the results before the offset, are not returned.

The “get” API method may return to the calling computing device the following outputs:

(i) an array of rows of genomic data. The returned rows of genomic data are one or more rows of genomic data matching the “query”, “limit”, and “starting” parameters;
(ii) a length indicating the number of rows that are included in the response;
(iii) a “next” value identifying a next row of genomic data that matches the “query” and “starting” parameters but that is not returned in the (i) array of rows of genomic data because of the “limit” parameter.

In general, the “next” value that is returned by an earlier “get” API method call can be used in a subsequent “API” method call to retrieve row(s) of genomic data that are not returned by the earlier “API” method call, that is, to continue where the earlier “get” API method left off.

For example, consider the situation in which an initial “get” API method call is made against a genomic table with ten rows total (i.e., 1, 2, . . . , 10), and that query that is passed with the “get” API method call produced a result set of only four of the ten rows: 2, 4, 9, 10. In some embodiments, if the earlier “get” API method call is limited to a “limit” of two, then the “get” API will return only rows 2 and 4, and a value of 9 for “next”. The “next” value of 9 can be used in a subsequent “get” API method call to retrieve the remaining rows of the result set, beginning with row 9. In some embodiments, the “next” parameter is an opaque int64 integer type.

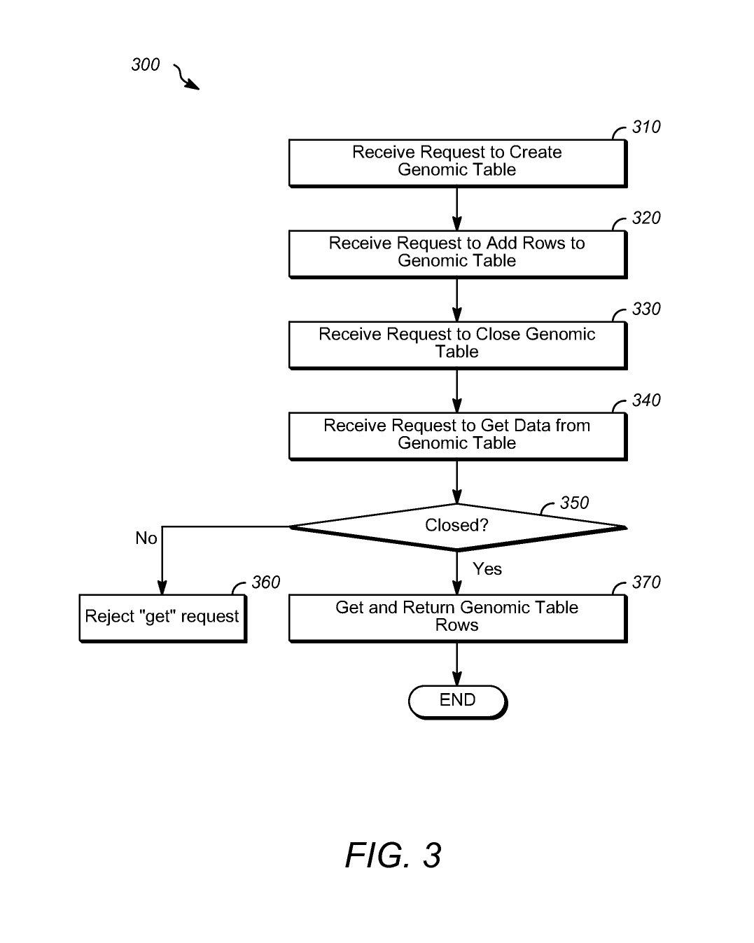

FIG. 3 illustrates exemplary process 300 which may be performed by a genomic information provider to provide genomic data to one or more client computing devices. At block 310, the genomic information provider receives a request from a client computing device to create a new genomic table. At block 320, the genomic information provider receives a request from a client computing device to add new rows of genomic data into the new genomic table. The rows of genomic data are stored at a storage device and/or service, which may be a cloud-storage device and/or service. At block 330, the genomic information provider receives a request from a client computing device to close, or finalize, the genomic table. In response to the request to close, the genomic information provider aggregates the rows that have been received for the genomic table, creates indices for the genomic table, and reorders the rows of the genomic table according to the indices.

Note, the closing process may take some time, but may be performed by the genomic information provider without requiring additional processing or computing resources from client computing devices. When the genomic information provider completes the processes that are needed for closing a genomic table, the genomic information provider marks the genomic table as closed.

At block 340, the genomic information provider receives a request from a client computing device to retrieve genomic data from the genomic table. The request includes a query. At block 350, the genomic information provider determines whether the genomic table has been closed. If the genomic table has not been closed, the retrieval request from the client computing device is rejected at block 360. If the genomic table has been closed, processing proceeds to block 370, where a lookup based on the received query is performed against the genomic table, and resulting genomic data, if any, are returned to the calling client computing device.

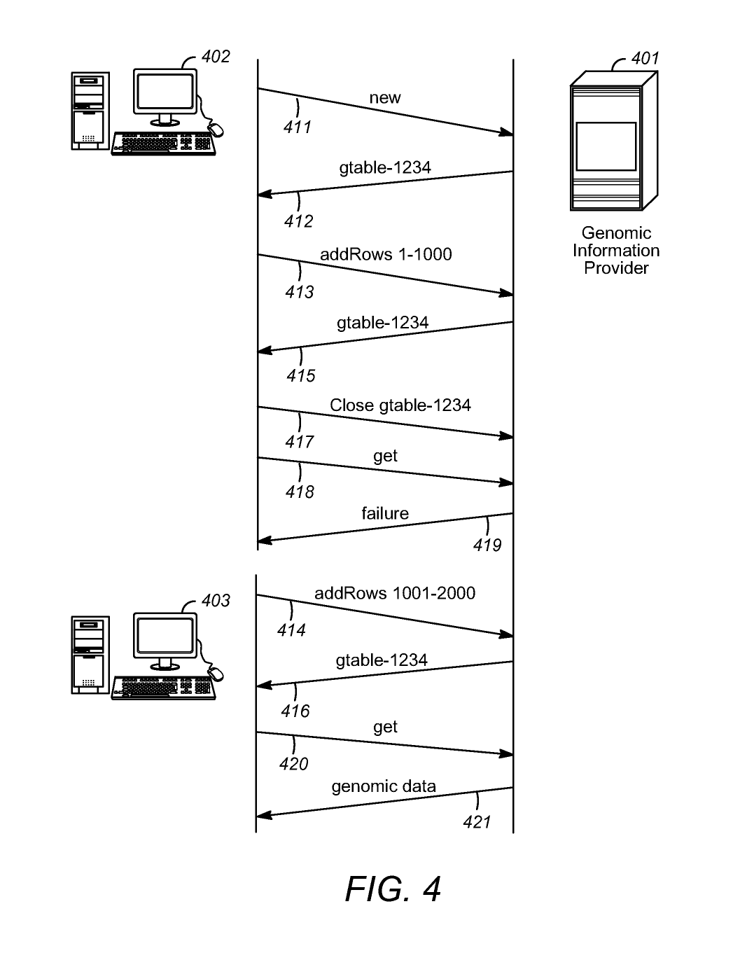

FIG. 4 illustrates exemplary network communications between a genomic information provider 401 and client computing devices 402 and 403 to carry out the transmission of genomic data for storage into genomic tables. Network transmission 411 between genomic information provider 401 and client computing device 402 may be a HTTP request over a suitable network such as the internet, which generally supports TCP/IP network transmissions. Via network transmission 411, client computing device 402 calls the “new” API method to request that genomic information provider 401 create a new genomic table. Via network transmission 412, genomic information provider 401 returns a genomic table identifier (e.g., a string in the form of “gtable-xxxx”) to client computing device 402 that identifies the newly created genomic table. Via network transmissions 413 and 414, client computing devices 402 and 403, respectively, call the “addRows” API method for the newly created genomic table. Via network transmissions 415 and 416, genomic information provider 401 responds to client computing devices 402 and 403, respectively, confirming the genomic table that is being added to. Via network transmission 417, client computing device 402 calls the “close” API method for the newly created genomic table. Via network transmission 418, client computing device 402 calls the “get” API method for the newly created genomic table. Via network transmission 419, genomic information provider 401 returns a value indicating failure. Genomic information provider 401 indicates failure because the closing processes for the genomic table have not been completed, that is, the genomic table is not yet in the “closed” state.

At a later time, via network transmission 420, client computing device 402 calls the “get” API to retrieve rows of genomic data from the newly created genomic table. At this later time, the closing of the genomic table is complete, thus, genomic information provider 401 returns a set of genomic data from the genomic table to client computing device 402 via network transmission 421.

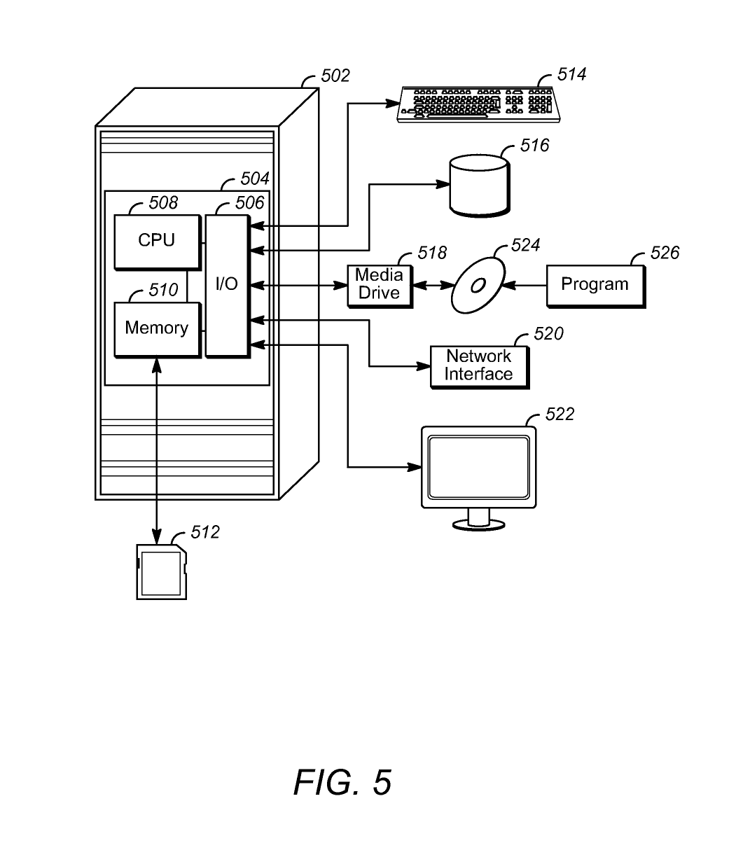

FIG. 5 depicts an exemplary computing system 500 configured to perform any one of the above-described processes. In this context, computing system 500 may include, for example, a processor, memory, storage, and input/output devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, in hardware, or in some combination thereof.

As shown in FIG. 5, the main system 502 includes a motherboard 504 having an input/output (“I/O”) section 506, one or more central processing units (“CPU”) 508, and a memory section 510, which may have a flash memory card 512 related to it. The I/O section 506 may be connected to a keyboard 514, a disk storage unit 516, a media drive unit 518, network interface 520, and/or a display 522. The media drive unit 518 can read/write a computer-readable medium 524, which can contain computer-readable programs 526 and/or data.

At least some values based on the results of the above-described processes can be saved for subsequent use. For example, portions of genomic data can be stored in memory (e.g., Random Access Memory), disk storage unit 516, and/or computer-readable medium 524, prior to being written to a cloud storage device via network interface 520.

Additionally, a computer-readable medium can be used to store (e.g., tangibly embody) one or more computer programs for performing any one of the above-described processes by means of a computer. The computer-readable medium can be a non-transitory medium. The computer program may be written, for example, in a general-purpose programming language (e.g., C, C++, Java, JSON, Python) or some specialized application-specific language.

Although only certain exemplary embodiments have been described in detail above, those skilled in the art will readily appreciate that many modifications are possible in the exemplary embodiments without materially departing from the novel teachings and advantages of this invention. Additionally, aspects of embodiments disclosed above can be combined in other combinations to form additional embodiments. Accordingly, all such modifications are intended to be included within the scope of this invention.

What is claimed is:

1. A computer-enabled method for transmitting genomic information from a genomic information provider to a computing device using one or more application programming interfaces (APIs) over a network, the method comprising:
storing in non-volatile storage, by the genomic information provider as tabular data, genomic information datasets;
receiving, by the genomic information provider via the one or more APIs over the network, a request for a subset of the genomic information datasets, wherein the request includes a genomic range index identifying the subset of the genomic information datasets; and
returning, by the genomic information provider to the computing device over the network, output comprising:
a plurality of table rows corresponding to the subset of the genomic information dataset, and
a length indicator indicating the number of table rows in the plurality of table rows,
wherein the genomic range index:
identifies a genomic interval on a chromosome,
comprises a first portion identifying the chromosome, a second portion identifying low genomic coordinates representing a low boundary of the genomic interval on the chromosome, and a third portion identifying high genomic coordinates representing a high boundary of the genomic interval on the chromosome.

2. The method according to claim 1, wherein the genomic information provider limits the plurality of table rows of the returned output to a maximum size, the method further comprising:
receiving, by the genomic information provider via the one or more APIs over the network, data representing the maximum size;
when the subset of the genomic information datasets exceeds the maximum size of the first output, returning in the output an index,
wherein the index identifies a missing portion of the subset of the genomic information datasets that is not returned in the plurality of table rows of the returned output.

3. The method according to claim 2, the method further comprising:
receiving, by the genomic information provider via the one or more APIs, a request for the missing portion of the subset of the genomic information datasets; and
returning, by the genomic information provider to the computing device, output comprising:
a plurality of table rows corresponding to the missing portion of the subset of the genomic information datasets.

4. The method according to claim 1,
wherein the one or more APIs includes an API named in the form of “/gtable-x/get” or “gtable-x/get”,
wherein “x” in the form refers to a string of a given length,
wherein the string identifies a genomic information dataset stored by the genomic information provider.

5. The method according to claim 1, wherein the low genomic coordinates and high genomic coordinates identified by the genomic range index defines a genomic interval that overlaps the subset of the genomic information dataset.

6. The method according to claim 5, wherein the low genomic coordinates and high genomic coordinates identified by the genomic range index defines a genomic interval that encloses the subset of the genomic information dataset.

7. The method according to claim 1, wherein the genomic information datasets include DNA sequence data.

8. The method according to claim 1, wherein the DNA sequence data include DNA reads and DNA mappings.

9. The method according to claim 1, wherein the output is returned by the genomic information provider to the computing device using JavaScript Object Notation.

10. The method according to claim 1, wherein the one or more APIs are invoked by computer-readable instructions distributed with a software development toolkit.

11. The method according to claim 1, wherein the storing of genomic information datasets by the genomic information provider as tabular data comprises:
transmitting, from the genomic information provider over the network to a cloud-based storage, the genomic information datasets; and
instructing the cloud-based storage to store the transmitted genomic information datasets.

12. A non-transitory computer-readable medium having computer-executable instructions, wherein the computer-executable instructions, when executed by one or more processors, causes the one or more processors to provide one or more application programming interfaces (APIs) for transmitting genomic information from a genomic information provider to a computing device over a network, the computer-executable instructions comprising instructions for:
storing in non-volatile storage, by the genomic information provider as tabular data, genomic information datasets;
receiving, by the genomic information provider via the one or more APIs over the network, a request for a subset of the genomic information datasets, wherein the request includes a genomic range index identifying the subset of the genomic information datasets; and
returning, by the genomic information provider to the computing device over the network, output comprising:
a plurality of table rows corresponding to the subset of the genomic information dataset, and
a length indicator indicating the number of table rows in the plurality of table rows,
wherein the genomic range index:
identifies a genomic interval on a chromosome,
comprises a first portion identifying the chromosome, a second portion identifying low genomic coordinates representing a low boundary of the genomic interval on the chromosome, and a third portion identifying high genomic coordinates representing a high boundary of the genomic interval on the chromosome.

13. The computer-readable medium according to claim 12, wherein the genomic information provider limits the plurality of table rows of the returned output to a maximum size, the computer-executable instructions further comprising instructions for:
receiving, by the genomic information provider via the one or more APIs over the network, data representing the maximum size;
when the subset of the genomic information datasets exceeds the maximum size of the first output, returning in the output an index,
wherein the index identifies a missing portion of the subset of the genomic information datasets that is not returned in the plurality of table rows of the returned output.

14. The computer-readable medium according to claim 13, the computer-executable instructions further comprising instructions for:
receiving, by the genomic information provider via the one or more APIs, a request for the missing portion of the subset of the genomic information datasets; and
returning, by the genomic information provider to the computing device, output comprising:
a plurality of table rows corresponding to the missing portion of the subset of the genomic information datasets.

15. The computer-readable medium according to claim 12,
wherein the one or more APIs includes an API named in the form of “/gtable-x/get” or “gtable-x/get”,
wherein “x” in the form refers to a string of a given length,
wherein the string identifies a genomic information dataset stored by the genomic information provider.

16. The computer-readable medium according to claim 12, wherein the genomic coordinates identified by the genomic range index defines a genomic interval that overlaps the subset of the genomic information dataset.

17. The computer-readable medium according to claim 16, wherein the genomic coordinates identified by the genomic range index defines a genomic interval that encloses the subset of the genomic information dataset.

18. The computer-readable medium according to claim 12, wherein the genomic information datasets include DNA sequence data.

19. The computer-readable medium according to claim 12, wherein the DNA sequence data include DNA reads and DNA mappings.

20. The computer-readable medium according to claim 12, wherein the output is returned by the genomic information provider to the computing device using JavaScript Object Notation.

21. The computer-readable medium according to claim 12, wherein the instructions for the storing of genomic information datasets by the genomic information provider as tabular data further comprises instructions for:
transmitting, from the genomic information provider over the network to a cloud-based storage, the genomic information datasets; and
instructing the cloud-based storage to store the transmitted genomic information datasets.

22. A genomic information system for providing one or more application programming interfaces (APIs) for transmitting genomic information to a computing device over a network, the genomic information provider comprising:
a network interface configured to communicate with a non-volatile storage cloud-based storage over the network;
one or more processors coupled to the network interface;
a memory coupled to the one or more processors, the memory comprising computer-executable instructions, which, when executed by the one or more processors, causes the one or more processors to:
store in the non-volatile cloud-based storage, as tabular data, genomic information datasets by transmitting the genomic information datasets using the network interface;
provide one or more APIs for receiving a request for a subset of the stored genomic information datasets, wherein the request includes a genomic range index identifying the subset of the genomic information datasets;
receive the request for a subset of the stored genomic datasets from a computing device over the network; and
return, using the one or more APIs, to the computing device over the network, output comprising:
a plurality of table rows corresponding to the subset of the genomic information dataset, and
a length indicator indicating the number of table rows in the plurality of table rows,
wherein the genomic range index:
identifies a genomic interval on a chromosome,
comprises a first portion identifying the chromosome, a second portion identifying low genomic coordinates representing a low boundary of the genomic interval on the chromosome, and a third portion identifying high genomic coordinates representing a high boundary of the genomic interval on the chromosome.

23. The genomic information system according to claim 22, wherein the genomic information system limits the plurality of table rows of the returned output to a maximum size, the memory further comprising computer-executable instructions configured to cause the processor to:
receiving, by the genomic information provider via the one or more APIs over the network, data representing the maximum size;
when the subset of the genomic information datasets exceeds the maximum size of the first output, return in the output an index,
wherein the index identifies a missing portion of the subset of the genomic information datasets that is not returned in the plurality of table rows of the returned output.

24. The genomic information system according to claim 23, wherein the memory further comprising computer-executable instructions configured to cause the processor to:
receive, by the genomic information system via the one or more APIs, a request for the missing portion of the subset of the genomic information datasets; and
return, by the genomic information system to the computing device, output comprising:
a plurality of table rows corresponding to the missing portion of the subset of the genomic information datasets.

25. The genomic information system according to claim 22,
wherein the one or more APIs includes an API named in the form of “/gtable-x/get” or “gtable-get”,
wherein “x” in the form refers to a string of a given length,
wherein the string identifies a genomic information dataset stored by the genomic information provider.

26. The genomic information system according to claim 22, wherein the genomic coordinates identified by the genomic range index defines a genomic interval that overlaps the subset of the genomic information dataset.

27. The genomic information system according to claim 26, wherein the genomic coordinates identified by the genomic range index defines a genomic interval that encloses the subset of the genomic information dataset

28. The genomic information system according to claim 22, wherein the genomic information datasets include DNA sequence data.

29. The genomic information system according to claim 22, wherein the DNA sequence data include DNA reads and DNA mappings.

30. The genomic information system according to claim 22, wherein the output is returned by the genomic information provider to the computing device using JavaScript Object Notation.
